(19) United States
(12) Patent Application Publication
(10) Pub. No.: US 2018/0247742 A1
(43) Pub. Date: Aug. 30, 2018

(54) METHOD FOR SHEATHING A PRODUCT IN STRAND FORM, CABLE, APPARATUS FOR THE METHOD, CONTROL METHOD FOR THE APPARATUS, AND COMPUTER PROGRAM PRODUCT

(71) Applicant: LEONI KABEL GMBH, NUERNBERG (DE)

(72) Inventors: BASTIAN HITZ, POSTBAUER-HENG (DE); FUK-TING WONG, NUERNBERG (DE)

(21) Appl. No.: 15/966,768

(22) Filed: Apr. 30, 2018

Related U.S. Application Data
(63) Continuation of application No. PCT/EP2016/075996, filed on Oct. 27, 2016.

(30) Foreign Application Priority Data
Oct. 28, 2015 (DE) 10 2015 221 102.9

(51) Int. Cl. H01B 13/16; B29C 64/135; B29C 70/74; H01B 3/00; H01B 13/14; B33Y 10/00

(52) U.S. Cl. CPC H01B 13/16; B29C 64/135; B33Y 10/00; H01B 3/00; H01B 13/14; B29C 70/742

(57) ABSTRACT

A method produces a cable. A sheath is applied to a product in strand form and the product in strand form is supplied, for this purpose, to an apparatus which has a bath containing a curable material. A build-up zone is formed in the bath, within which build-up zone the curable material is at least partially cured by an exposure source and through which the product in strand form is conveyed lengthwise in a conveying direction, so that cured material is arranged on the product in strand form and is conveyed out of the bath together with the product in strand form as a sheath on the product in strand form.

### CROSS-REFERENCE TO RELATED APPLICATION

This is a continuation application, under 35 U.S.C. § 120, of copending international application No. PCT/EP2016/075996, filed Oct. 27, 2016, which designated the United States; this application also claims the priority, under 35 U.S.C. § 119, of German patent application No. DE 10 2015 221 102.9, filed Oct. 28, 2015; the prior applications are herewith incorporated by reference in their entirety.

### BACKGROUND OF THE INVENTION

### Field of the Invention

The invention relates to a method, in particular for the production of a cable, to such a cable, to an apparatus for the method, to a control method for the apparatus, and to a computer program product.

Extrusion methods in which a jacket is extruded onto a product in strand form which is fed to an extrusion head are known in principle for manufacturing cables. The material required to this end is provided to the extrusion head by way of an extruder. Extrusion methods are usually distinguished by a high production rate, however offer only a limited potential in terms of the design of the jacket, in particular the shape and the contour of the latter.

In order for particularly complex structures to be produced, the use of a 3D production method which is distinguished by a high design capability of the object to be produced is possible. For example, a stereolithographic system by which a three-dimensional object is made layer-by-layer from a liquid material by successively curing a plurality of layers lying on top of one another by exposure is described in U.S. Pat. No. 5,236,637. However, such methods often have only a low production rate, in any case as compared to the extrusion methods mentioned above, and are therefore usually used in the rapid prototyping sector and are suitable for mass production or continuous production only within limits.

By contrast, a particularly rapid 3D production method, for example, is described in U.S. patent publication No. 2015/0097316 A1 and enables continuous manufacturing instead of manufacturing layer-by-layer. To this end, a superimposition of two gradients is utilized, this leading to the configuration of a thin build-up zone in the material to be cured. The introduction of an inhibitor into the material is essential herein, the inhibitor in regions preventing curing by way of the exposure.

### BRIEF SUMMARY OF THE INVENTION

Against this background, it is an object of the invention to specify an improved method for sheathing a product in strand form with a jacket, in particular for the production of a cable, and an apparatus which is suitable to this end. The jacket herein is to be designable with as much freedom as possible, and a production rate that is as high as possible is to be simultaneously attained. Furthermore, a cable having such a jacket, a suitable control method for the apparatus, and a computer program product are to be specified.

The object is achieved according to the invention by a method having the features according to the independent method claim. Advantageous design embodiments, refinements, and variants are the subject matter of the dependent claims. The object is furthermore achieved by a cable having the features according to independent cable claim, by an apparatus having the features according to the independent apparatus claim, by a control method having the features according to independent control method claim, and by a computer program product having the features according to independent computer program claim. The design embodiments and advantages mentioned herein in the context of the method apply in analogous manner also to the cable, the apparatus, the control method, and the computer program product, and vice versa. The computer program product is a physical data carrier, or else only a data file, in each case containing an executable program which is configured for automatically executing the control method when the program is installed on a computer.

The method serves in particular for the production of a cable and in general for sheathing a product in strand form. A jacket is applied herein to the product in strand form, and the product in strand form to this end is fed to an apparatus which has a bath of a curable material. A build-up zone within which the curable material is cured at least partially by at least one exposure source and through which the product in strand form is conveyed longitudinally in a conveying direction is configured in the bath, such that cured material is disposed on the product in strand form and, as the jacket on the product in strand form, is conveyed conjointly with the latter out of the bath. A product in strand form is generally understood to be an elongate, in particular flexible element which forms a carrier material, or a carrier, respectively, for the jacket. For example, the product in strand form is configured as a cable, or else as a part-structure of a cable, for example a cable core, one or a plurality of conductors, or one or a plurality of wires. Furthermore, a product in strand form is understood to be a cable which for connecting the cable to another apparatus can already have a connection element, for example a plug. The term “sheathing” or “jacket” is understood to be an application of material that takes place at least in part, in particular an application of material in portions, or an incomplete application of material, a partial sheathing, or else a complete sheathing. The term “bath” is understood to be substantially a liquid medium.

The invention is based in particular on the observation that a high production rate and thus in principle an economically expedient production of comparatively great length in the range of several meters or even kilometers is possible by means of the method mentioned in U.S. patent publication No. 2015/0097316 A1. A core concept now lies in particular in using the method not only for producing individual, stand-alone structures, but instead to feed a semi-finished product to which such a structure is applied. The semi-finished product, in combination with the structure applied thereto, then forms the finished object or in turn again a semi-finished product for yet another method. When combined with the potential of continuous manufacturing and with a high production rate, the sheathing of a product in strand form according to the invention as a semi-finished product having a structure that is applied as a jacket is then particularly advantageous. The method introduced here thus enables, on the one hand, a particularly high design capability and freedom of design in the configuration of the jacket, and simultaneously an economical production rate which moreover also enables the production of large quantities, this being advantageous in particular in the context of cables.

In the case of the method according to the invention, the jacket is thus successively built up from the curable material in that the latter is cured in the build-up zone while the product in strand form is conveyed through the bath. On account thereof, the jacket then grows in the conveying direction along the product in strand form, said jacket thus being applied to, or else added to, the product in strand form in the longitudinal direction thereof. In this sense, there are certain similarities to an extrusion method, specifically in as far as an initially liquid or viscous material is offered up to the product in strand form and is cured thereon. As opposed to an extrusion method, shaping and curing of the jacket are performed simultaneously, specifically by way of the exposure by the exposure source. The shaping moreover is not performed by way of a physical spatial delimitation by an aperture, as is the case in an extrusion head, but by way of targeted exposing and curing only in the desired regions of the build-up zone by an exposure pattern that is generated by the exposure source. Moreover, an extruder for feeding material is not required, instead the material for the jacket is provided by way of the bath. The simultaneous shaping and curing also contrasts to an application by a dipping bath, for example, in which a product in strand form is guided through a dipping bath and is cured only subsequently, that is to say upon leaving the dipping bath.

Overall, the method according to the invention is thus to some extent also comparable to a lithographic method, wherein however the build-up of the jacket is advantageously not performed in a discrete, layer-by-layer manner, but a continuous or at least quasi-continuous build-up is performed in the conveying direction. The product in strand form is thus conveyed in particular continuously through the bath and through the build-up zone. The method is also referred to as additive extrusion by virtue of the in particular continuous manner of applying the jacket, and of the free design capability when adding on the latter.

The jacket is advantageously configured as a structured sheathing. By virtue of the particularly flexible method and in particular of the wide range in terms of the degree of freedom in design in terms of the exposure, structures of almost arbitrary complexity can be made as the jacket for the product in strand form, even precisely such structures which are not producible by conventional methods, for example extrusion, injection molding, or exjection methods. The jacket as a three-dimensional sheathing or coating, in this instance is freely configurable, for example, in terms of functionality and/or visual appeal; even undercuts and complex functions can be implemented in a simple manner and with a low production complexity. The method is in particular suitable for both mass or volume production as well as for making individual pieces or prototypes.

The curable material is exposed for curing. The type of exposure herein depends on the material chosen. In one suitable embodiment, the material is curable, in particular capable of being polymerized or cross-linked, by exposure to UV rays. Alternatively, the use of other electromagnetic radiation such as, for example, X rays or microwaves, is also conceivable. The curable material is preferably continuously curable such that the hardness of the material, that is to say the degree of cross-linking, is set by setting the duration and the intensity of the exposure, and the jacket in this way, depending on the exposure, is configured having dissimilar, in particular mechanical, properties.

In general, the material is cured only in such regions in which the material is exposed. Almost arbitrary structures and cross-sectional geometries of the jacket can then be generated by choosing a suitable exposure pattern which is provided by the exposure source. The exposure source is, for example, a projector which projects the exposure pattern into the bath. Alternatively, a combination of an illumination device, for example a lamp or a light conductor, and a mask or optical imaging system, is also conceivable as an exposure source. The exposure source can moreover also have deflection elements, for example mirrors, in order for the radiation to be guided into the bath by way of a suitable path. One or a plurality of lasers or laser scanners are in principle also suitable as the exposure source.

The jacket is advantageously applied as a structure, in particular in a layer-less manner, that is to say continuously, to the product in strand form, on account of which the adhesion of the material to the product in strand form is significantly improved. Moreover, the method is capable of being completely automated and is also capable of being used as an in-line process in a superordinate production method. Moreover, the method can be refined in a particularly simple manner and be adapted to the most diverse production processes and production requirements. In one design embodiment, the method is moreover applied multiple times in succession such that a product in strand form that has been sheathed by means of the method is again fed to the method so as to configure a further jacket and to in this way make an overall jacket which has a particularly high degree of design capability.

The method advantageously enables the configuration of symmetrical as well as asymmetrical, three-dimensional structures as the jacket on a surface of the product in strand form, the latter likewise having either a symmetrical or asymmetrical geometry, in particular cross-sectional geometry, in relation to the longitudinal axis of said product in strand form. Geometries which are substantially symmetrical and in particular round, for example such as is the case in a round conductor, rod conductor, or bunched conductor, or an optical fiber, as the product in strand form, are preferable. However, for example flat conductors, or angular cross-sectional geometries, or combinations of the aforementioned possibilities, in particular also geometries of a bundled product in strand form, are also conceivable and suitable.

As has already been mentioned, the jacket is applied to the product in strand form, that is to say in particular molded to the latter, by way of in particular continuous curing in the build-up zone. The build-up zone herein is configured as a part-region of the bath, in that an inhibitor is introduced into the bath, said inhibitor in an inhibitor inflow direction generating an inhibitor gradient along which the curing capability of the material is reduced. The exposure by the exposure source is superimposed on this inhibitor gradient in such a manner that a thin layer, that is to say a thin layer of approximately 0.01 to 100 μm, results as a build-up zone within which the concentration of the inhibitor is sufficiently low so as to enable curing, and within which the exposure simultaneously is adequately intense in order to actually cause curing. The build-up zone is specifically configured, that is to say that the thickness and the position of said build-up zone in the bath is set in particular, by setting the feed rate of the inhibitor into the bath and the exposure in a corresponding manner.

In one preferred design embodiment, the product in strand form forms a core of a cable. The product in strand form is preferably an electrical or optical transmission element, and in particular a conductor or a wire, alternatively in particular a bunched conductor. In general, the product in strand form forms a cable core which is surrounded or shrouded by the jacket as a cable jacket. The jacket herein is not necessarily configured on the entire circumference or in a solid manner, but in one advantageous variant rather has clearances and interruptions in order for the mechanical, electrical, or other properties of the jacket to be set in particular. The jacket in one advantageous variant moreover has different longitudinal portions having dissimilar properties. Alternatively, the product in strand form per se is a cable, in particular having a jacket, a line, or a conductor, which is sheathed. In principle, an optical fiber or a hose are also suitable as a product in strand form.

In the case of the method, the product in strand form is expediently fed by way of a suitable storage and re-use support system and received by the latter once the jacket has been applied. For example, the product in strand form is mounted on a drum from which the product in strand form is unwound and conveyed into the bath. After curing, the sheathed product in strand form is conveyed out of the bath and then, for example, again wound onto a further drum and stored. Depending on how the fed product in strand form and the final product, that is to say the sheathed product in strand form, are configured, a conveyor belt and/or collection container or duct are/is used alternatively or in combination with the drums mentioned in order for the product in strand form to be fed and/or the sheathed product in strand form to be stored. In one further alternative, the sheathed product in strand form is fed directly to a making-up process or to other further processing.

In one advantageous refinement, the support system has a positioning apparatus in order for an optimal positioning of the product in strand form in relation to the build-up zone to be set and to be guaranteed in particular at the start of the method, but in particular also during the method. To this end, for example a distance measuring system or a proximity sensor, and in general preferably a non-contacting measuring method by means of a sensor operating in a contactless manner, is/are used for determining the position of the product in strand form.

The support system furthermore expediently has a control system for conveying the product in strand form, that is to say in particular a control system for controlling or regulating the conveying speed. In one advantageous design embodiment, the conveying speed is set differently in portions, so as to provide only specific longitudinal portions of the product in strand form with a jacket, for example, and to omit other longitudinal portions. Those longitudinal portions without a jacket are then conveyed in a correspondingly faster manner. In general, a reversal of the conveying direction, for example in order for a specific longitudinal portion to be guided multiple times through the build-up zone, is also conceivable and suitable.

A plurality of zones are typically configured in the bath when in operation, specifically a dead zone or a non-curable zone, in which the inhibitor is present at such a concentration that curing of the material is prevented, a normal zone or curable zone in which the curable material is curable by exposure, and the build-up zone which is disposed in the border region between the dead zone and the normal zone and in which the curable material for curing is exposed in a locationally selective manner. The normal zone and the dead zone herein are not necessarily sharply delineated from one another, but rather are defined by the non-homogenous distribution and concentration of the inhibitor in the bath. The build-up zone in this instance is defined significantly by a specific concentration of the inhibitor and by the exposure by means of the exposure source.

The bath is typically mounted in a vessel which in one preferred design embodiment has an opening through which the product in strand form is fed to the bath. The vessel herein is, for example, a flat tub or tray, having a base and a lateral periphery forming an open cavity in which the curable material is conveyed in order for the bath to be formed. Feeding the curable material is performed, for example, by way of a suitable container having a suitable outlet to the vessel, or connector to the vessel. In order in this instance for the product in strand form to be able to be introduced into the bath, the vessel has an opening which in particular in the filled state of the bath is covered by the latter such that the product in strand form when running into the vessel is thus directly conveyed into the bath. The opening is in particular incorporated in the base of the vessel such that the conveying direction in one variant is conveyed substantially perpendicularly to the base and to an extent plane of the in particular flat bath. On account thereof, the path through the bath to the build-up zone is kept particularly short.

The product in strand form is advantageously conveyed in the same direction, specifically in the conveying direction, through the opening and through the build-up zone. The opening is in particular adapted to the cross-sectional contour of the product in strand form such that as little as possible of the still-liquid, curable material is lost on account of the opening.

Alternatively, a design embodiment without an opening is also expedient, in which the product in strand form is conveyed into the bath by way of a suitable deflection mechanism and in particular by way of an open side or upper side of the vessel. In a simple, exemplary design embodiment, a deflection roller is attached to the base of the vessel, such that the product in strand form in this instance for example runs laterally in an oblique manner into the bath and initially passes through the normal zone, is then deflected in the dead zone, and finally runs through the bath and the build-up zone from below.

A guide element through which, or generally by which, the product in strand form can be conveyed into the bath and by which the vessel in the region of the opening is sealed is advantageously disposed on the opening. The guide element thus serves in particular for equalizing any difference between a diameter of the product in strand form and a diameter of the opening, and prevents the configuration of a leak by way of which the material could potentially exit. The guide element in one variant is thus at the same time a seal or at least fulfils a sealing function.

The guide element advantageously has a diaphragm and/or a guide sleeve and/or a valve and/or a flap. The guide element in one variant is composed of one of these elements. The guide element is in particular flexible, in particular in such a manner that the guide element adapts to a circumferential contour of the product in strand form that potentially varies in the longitudinal direction, so as to achieve sealing that is as optimal as possible. In a first variant, the guide element is a guide sleeve, in particular a rigid guide tube, or in particular a flexural guide hose, or has one thereof. A guide element of this type preferably extends only through the vessel to the beginning of the bath, that is to say specifically does not extend into the bath. The guide element in a second variant is a diaphragm or has a latter, wherein the product in strand form in this instance is conveyed through the diaphragm, the diaphragm in this instance automatically bearing in a flush manner on the surface of the product in strand form and sealing the opening. The guide element in a third variant is a valve or has a latter, wherein the valve is expediently configured in the manner of a non-return valve or of a cardiac valve, enabling passage in particular only in one direction, specifically the conveying direction. The guide element in a fourth variant is a flap or has a latter. The flap closes the opening in the case of no product in strand form being conveyed through the opening, and opens in a corresponding manner when the product in strand form is introduced. Further suitable variants of the guide element are derived by combining the above-mentioned variants. A combination of a guide sleeve that is fixedly attached to the vessel with a diaphragm or a diaphragm similar to that of a cardiac valve is particularly suitable, for example.

An intermediate space in which a backpressure for retaining the curable material is advantageously built up by a support medium is potentially configured between the product in strand form and the guide element. This design embodiment is particularly suitable in combination with the guide sleeve described above. The support medium is streamed into the guide element on that side of the vessel that faces away from the bath, that is to say from the outside, and thus forms a counter pressure which prevents the liquid, curable material advancing through the guide element. The backpressure herein is expediently set precisely in such a manner that the material is retained and the support medium at the same time does not flow into the bath, thus that overall an equilibrium of forces between the bath and the support medium is set.

A gas or a liquid (liquid medium) as the support medium is advantageously streamed in the conveying direction into the intermediate space. In other words, a gaseous or liquid support medium is streamed in the conveying direction into the intermediate space. In a first variant, the inhibitor, that is to say in particular oxygen, is used as the support medium; in a second variant an in particular inert medium which preferably does not react with the curable material and/or does not influence curing is used. In a third variant, a medium which is at the same time used for a pre-treatment of the surface of the product in strand form is used.

The vessel advantageously has a semi-permeable wall, and the build-up zone is configured in that an in particular gaseous inhibitor is introduced through the wall into the bath. The semi-permeable wall is in particular the base of the vessel, or is part thereof. The bath in this instance is disposed as a thin liquid layer on the wall and is thus impinged with the inhibitor from below such that an inhibitor gradient that decreases towards the top is configured. Accordingly, the dead zone herein is configured on the bottom of the bath. In particular, the opening is also incorporated in the wall.

The exposure is in particular also performed through the wall, that is to say that the exposure source radiates from the outside through the wall into the bath. The exposure herein is performed preferably in a radiation direction which in the bath corresponds to approximately the direction of the inhibitor gradient, that is to say the rays are preferably beamed perpendicularly through the wall so as to in particular avoid any offset by virtue of the refraction in the wall. The exposure is expediently performed in the conveying direction, or alternatively so as to be oblique to the latter. In principle, a radiation that is oblique in relation to the wall, in which the offset is expediently taken into account in the positioning and alignment of the exposure source and/or in the conception of the exposure pattern, is also conceivable and suitable. However, the radiation is usually weakened in the case of the propagation through the bath such that a path that is as short as possible to the desired build-up zone is preferred. It is necessary in particular for the radiation to be beamed into the bath by way of the dead zone so as to obtain a build-up zone that is as thin as possible, since the radiation in the case of an exposure in the opposite direction would initially cure an undesirably large quantity of material in the normal zone. However, initial curing by way of the inhibitor is prevented in the case of a radiation by way of the dead zone; curing behind the build-up zone in this instance is prevented in particular in that the radiation there, by virtue of the propagation through the bath, is weakened to a sufficient extent.

In one potential design embodiment, the wall runs substantially flat and perpendicularly to the conveying direction. In one advantageous alternative, however, the wall runs obliquely to the conveying direction, that is to say not perpendicularly and not parallel thereto, but in particular at an angle between approximately 30 and 60°. The conveying direction herein refers in particular to the conveying direction in the region of the build-up zone. The exposure herein is preferably performed so as to be substantially perpendicular to the wall, that is to say in this instance accordingly in a manner oblique to the conveying direction. In other words, the curable material is preferably cured in that the latter by the exposure source is exposed through the wall and obliquely to the conveying direction. Alternatively, the exposure is performed only obliquely to the conveying direction. This design embodiment is based in particular on the concept that the product in strand form and/or the guide element potentially leads to a disadvantageous shading of the exposure source, an optimal exposure and thus curing of the material under certain circumstances not being possible precisely in the critical region on the surface of the product in strand form. This is addressed by the exposure that is oblique in relation to the conveying direction such that the exposure source in this instance is aligned so as to be precisely not in the direction of the conveying direction and of the longitudinal axis of the product in strand form, but rather so as to be lateral in relation to the product in strand form. In order in this instance for the path of the radiation through the material to be kept as short as possible, as has already been mentioned above, the wall is expediently also disposed so as to be oblique in relation to the product in strand form and to the conveying direction.

In one suitable design embodiment, the wall runs perpendicularly to the conveying direction, and the exposure source is disposed so as to be eccentric in relation to the product in strand form. “Eccentric” is understood to mean in particular that the exposure source has a specific extent and dimension, having a center which is not disposed along the longitudinal axis of the product in strand form, being offset thereto in the radial direction. Alternatively or additionally, the exposure source is disposed obliquely, thus having a radiation direction which is not parallel with the conveying direction.

The wall advantageously runs in a rotationally symmetrical manner in relation to the conveying direction, in particular along a conical shell surface, and forms a tip through which the product in strand form is conveyed into the bath. The opening and optionally the guide element herein are in particular also disposed on the tip, or form the latter. The wall in this instance encloses a correspondingly rotationally symmetrical cavity in which the bath is disposed. The inhibitor is then introduced by way of the wall, that is to say the shell face, such that in the case of a conical shell-surface-shaped wall, for example, a correspondingly conical shell-surface-shaped dead zone also results. By way of a corresponding exposure perpendicular to the wall, the build-up zone in this instance is also conical shell-surface shaped. In general, the build-up zone follows the profile of the wall. Moreover, by way of the rotationally symmetrical embodiment, an exposure that in relation to the conveying direction is oblique and in relation to the wall is in particular perpendicular is capable of being carried out in a particularly simple manner. A further advantage results in particular also from the build-up zone which now is oblique in relation to the conveying direction, on account of which in this instance the jacket at a given longitudinal position of the product in strand form is successively built up from the inside to the outside, so to speak, and precisely not simultaneously as in the case of a build-up zone that is aligned perpendicularly to the conveying direction. The mechanical strength of the jacket is in particular significantly improved on account thereof. Alternatively, but preferably additionally, the exposure source is rotationally symmetrical in relation to the conveying direction. The explanations made in the context of the wall apply in analogous manner also to the exposure source.

The curable material is advantageously exposed by a plurality of exposure sources emanating from different directions. This design embodiment having a plurality of exposure sources is particularly suitable for the oblique exposure mentioned above, such that an exposure is performed from a plurality of directions, wherein the respective exposure patterns in this instance, in the sum thereof, result in precisely the desired exposure pattern, any shading, in particular on account of the superimposition of the radiation from different directions, being compensated for.

In one variant, an optical sensor system with feedback is used in order for the method to be optimized.

Depending on the design embodiment, the product in strand form has a more or less complex circumferential contour, wherein “circumferential contour” here is understood in particular to be the border in the cross section perpendicular to the longitudinal direction of the product in strand form. An exposure pattern which is adapted to the circumferential contour is preferably generated by the exposure source, such that optimal curing of the curable material is performed in particular on the surface of the product in strand form, and the jacket is connected or bonded to the product in strand form in an optimal manner.

In one variant, the circumferential contour varies along the product in strand form, and the exposure pattern is adapted to the variable circumferential contour while the product in strand form is conveyed through the bath. For example, in the case of a projector as an exposure source, this is achieved by playing a corresponding video. In general, a temporally variable exposure pattern is thus used, the exposure pattern in combination with the conveying speed of the product in strand form leading to a modified exposure along the product in strand form. The use of a variable mask or of a scanner, or in general of a movable exposure source, is also conceivable to this end.

An adaptation to the circumferential contour is of particular importance in the case of a braid or of a bunched conductor as the product in strand form. In the case of the latter, a plurality of wires are usually twisted together such that overall a wound or helical profiled surface results. The exposure pattern in particular in this case is advantageously adapted to the circumferential contour in that the exposure source is rotated relative to the product in strand form and about the conveying direction. This is based on the insight that in the case of a wound profiled surface, a translatory movement in the longitudinal direction in relation to this surface is equivalent to a rotation. Instead of continuously modifying the exposure pattern in order for the latter to be adapted to the quasi-rotating circumferential contour, the exposure source is now simply rotated relative to the conveying direction about the product in strand form and thus follows the wound surface such that a continual adaptation of the exposure pattern is no longer required at least in the region of the surface of the product in strand form.

The jacket is advantageously configured as a jacket that is variable in the conveying direction in that the curable material is exposed by way of an exposure pattern, preferably by way of a temporally variable exposure pattern. In order for such a jacket that varies in the longitudinal direction to be configured, the exposure pattern is expediently temporally modified. This modification is performed in particular depending on the conveying speed. The resolution of the method, that is to say the degree of detail possible in the configuration of the jacket, in particular in the longitudinal direction, herein depends in particular on the repeat rate of the exposure source, that is to say on the rate at which a modification of the exposure pattern is generated. A higher resolution can also be achieved by way of a reduced conveying speed; however, in the interest of a process that is as rapid as possible it is in this instance advantageous for the exposure source to have a repeat rate that is as high as possible. The conveying speed is moreover significantly determined by the curing rate, wherein the curing rate in turn can be influenced by the (light) energy introduced.

In one suitable design embodiment, the jacket is configured as a jacket that is variable in the conveying direction in that dissimilarly curable materials are used. The dissimilar materials in this instance cure at dissimilar rates, for example, or after curing have a dissimilar degree of hardness, such that the jacket is configured having dissimilar jacket portions which have dissimilar properties, for example dissimilar hardnesses or flexural capabilities.

Before the product in strand form is conveyed into the bath, the product in strand form is advantageously pre-treated and preferably cleaned in a pre-treatment. In general, in particular a preparation of the surface of the product in strand form is generally performed in the pre-treatment, in order to improve the adherence of the material from the bath in the subsequent application and curing. Such a pre-treatment in this instance comprises, for example, cleaning of the surface, or applying an additional adhesive or a three-dimensional adherence or adhesive structure, so as to improve the bonding of the material. Improved bonding herein is achieved in particular chemically, for example by means of an adhesive, and/or mechanically, for example by way of an additional surface structure. In one variant, a sacrificial structure which subsequently to the configuration of the jacket is removed again, for example by dissolving, is applied in the pre-treatment. In one advantageous design embodiment, the product in strand form is heated in a pre-treatment.

Alternatively or additionally, the product in strand form in a pre-treatment is suitably guided through a pre-treatment medium or a pre-treatment bath.

In one expedient refinement, a slide, release, or oil coating is applied to the product in strand form by the pre-treatment medium or of the pre-treatment bath. On account thereof, easier stripping of the insulation is achieved for later contacting, in particular.

The curable material in portions is advantageously exposed and cured to dissimilar degrees in the conveying direction and/or in the radial direction, on account of which a plurality of jacket portions having dissimilar properties are configured. This is based on the insight that a dissimilar curing, in particular a dissimilar degree of cross-linking of the material, leads to dissimilar mechanical, chemical, physical, and/or electrical properties, that is to say that these properties are capable of being set by a controlled curing, that is to say presently by an adapted exposure time. For example, a more intense cross-linking is performed in the case of a longer exposure, and the corresponding jacket portion is less flexurally elastic, that is to say is more rigid and in particular mechanically more robust. Accordingly in this instance, a jacket portion cured to a lesser extent is more flexurally elastic. The dissimilar jacket portions herein can be disposed sequentially in the radial direction, that is to say perpendicularly to the longitudinal direction of the product in strand form, and/or sequentially in the longitudinal direction.

The product in strand form, having the jacket, after the bath is advantageously fed to a post-treatment. For example, a holding element that was previously attached to the product in strand form is removed herein. Alternatively or additionally, the sheathed product in strand form is cleaned. Alternatively or additionally, the sheathed product in strand form is made up, for example in the case of the jacket not being suitable for winding up on a cable drum.

In one advantageous variant, the post-treatment varies in portions so as to configure a plurality of jacket portions having dissimilar properties. In one suitable design embodiment, an only portion-by-portion and exemplary thermal treatment is carried out in order for the jacket to be further cured only in portions, and for a plurality of jacket portions having dissimilar flexural elasticities to be configured in this way. A subsequent additional radiation in the context of a post-treatment is also conceivable.

The bath is advantageously composed of a plurality of different curable materials which in particular are disposed so as to be layered in the conveying direction, and the jacket is configured in portions from dissimilar materials in that the build-up zone is configured in a temporally sequential manner in the dissimilar curable materials. To this end, only one vessel is advantageously required. The dissimilar materials therein are thus disposed in particular in a layered manner.

Jacket regions having dissimilar materials are configured by way of a suitable process management, in particular an actuation of the light source and/or of the inhibitor, wherein the material of the jacket varies in the radial direction and/or in the axial direction.

A bath having a plurality of dissimilar materials is also implementable in such a manner that the one material is initially retrieved or pumped away, and another material is then filled. However, a bath having a plurality of material layers enables a significantly higher production rate. By controlling the introduction of the inhibitor into the bath, the build-up zone is then displaced, repositioned, or offset in particular in the conveying direction and in general in a stacking direction of the material layers, such that one of the materials is selectable for curing. In one exemplary embodiment, the build-up zone is in this instance initially placed in a first material layer, the product in strand form is conveyed through the bath, and a first jacket portion from a first material is applied. The build-up zone thereafter is displaced to a second material layer; the conveying of the product in strand form is optionally stopped herein. A second jacket portion from a second material is subsequently configured. The two jacket portions in this example are disposed sequentially in the longitudinal direction. In one variant, the product in strand form after the configuration of the first jacket portion is moved backward, and the second jacket portion is then applied to the first jacket portion. The different materials in the cured state differ, for example, in terms of their mechanical, electrical, chemical, and/or physical properties, such that in this instance a jacket that is adapted to meet requirements in portions is configured. This is expedient, for example, in the case of a cable which along the longitudinal direction thereof passes different environments having dissimilar environmental conditions and requirements set for the jacket.

Prior to the application of the jacket, a holding element which is used as the starting point for configuring the jacket is advantageously attached at a predefined longitudinal position of the product in strand form. The holding element is also referred to as the material guide element. This holding element is in particular releasable or, for example chemically, soluble, and serves primarily as a holding point for the jacket, in particular at the beginning of the method. The holding element herein is, for example, a plate or a protruding structure which in particular extends substantially perpendicularly to the longitudinal direction of the product in strand form, and is attached, in particular fastened, to the latter. Alternatively, the holding element is configured along the product in strand form, either continuously or at discrete, repeated longitudinal positions. In this instance, the jacket, proceeding from the holding element, is grown thereon along the product in strand form. The holding element thus serves quasi in particular for pulling the jacket out of the bath and for additional mechanical support should the bonding of the jacket to the product in strand form not yet be sufficient at the beginning. Accordingly, the size and the structure of the holding element are suitably selected in terms of the adhesion of the in particular cured material on the product in strand form. The holding element is expediently conceived as a sacrificial structure and is removed once the jacket has been made.

Other features which are considered as characteristic for the invention are set forth in the appended claims.

Although the invention is illustrated and described herein as embodied in a method for sheathing a product in strand form, a cable, an apparatus for a method, a control method for the apparatus, and a computer program product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE SEVERAL VIEWS OF THE DRAWING

FIG. 1 is a diagrammatic, sectional view of an apparatus for sheathing a product in strand form according to the invention;

FIG. 2 is a sectional view of an alternative apparatus for sheathing the product in strand form;

FIG. 3 is a sectional view of a further alternative apparatus for sheathing the product in strand form; and

FIGS. 4A and 4B are sectional views in each case showing a method step for sheathing the product in strand form with dissimilar materials.

### DETAILED DESCRIPTION OF THE INVENTION

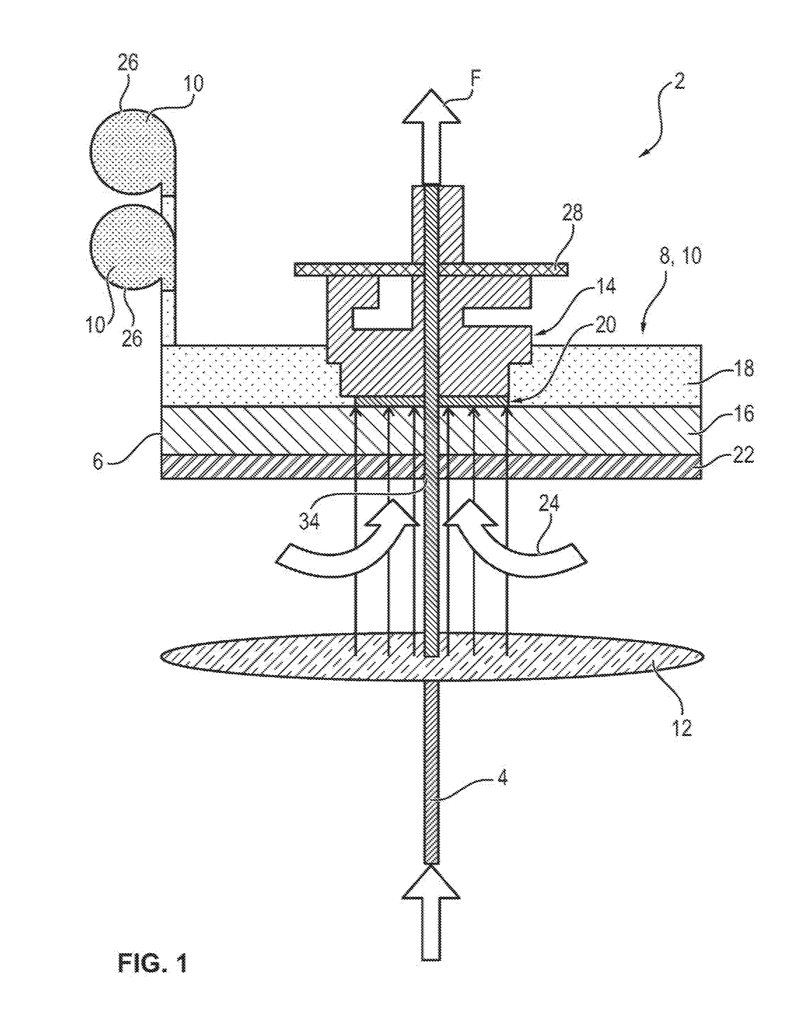

Referring now to the figures of the drawings in detail and first, particularly to FIG. 1 thereof, there is shown an apparatus 2 for sheathing a product in strand form 4. The product in strand form 4 is an electrical conductor, for example. The apparatus has a vessel 6 in which a bath 8 of a curable material 10 is disposed, the curable material 10 being cured by an exposure source 12 and disposed as a jacket 14 on the product in strand form 4. The method applied here is distinguished in particular in that the method is continuous, that is to say that the jacket 14 is continuously configured and, proceeding from the bath 8, is successively built up in a conveying direction F in the direction of a longitudinal axis of the product in strand form 4.

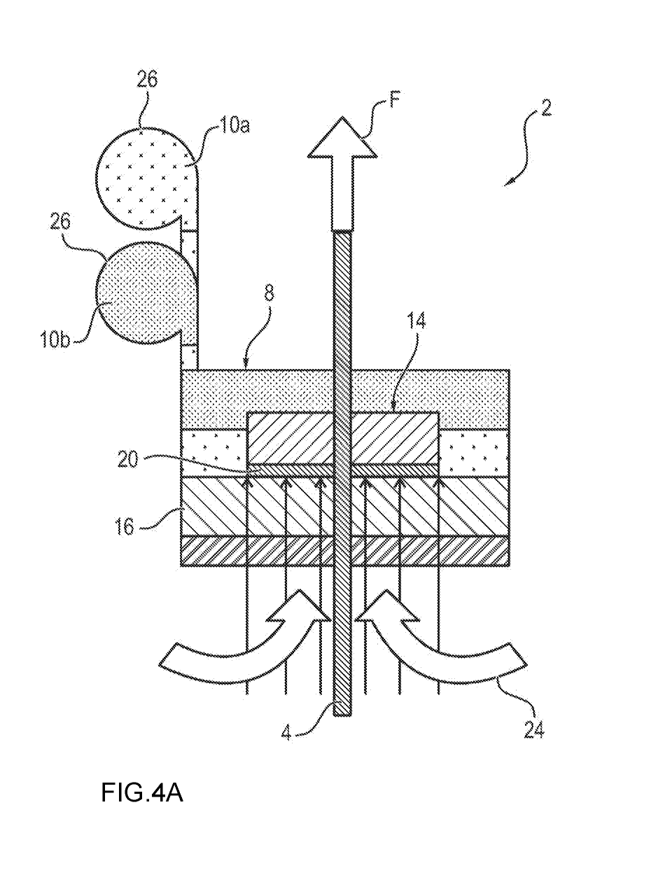

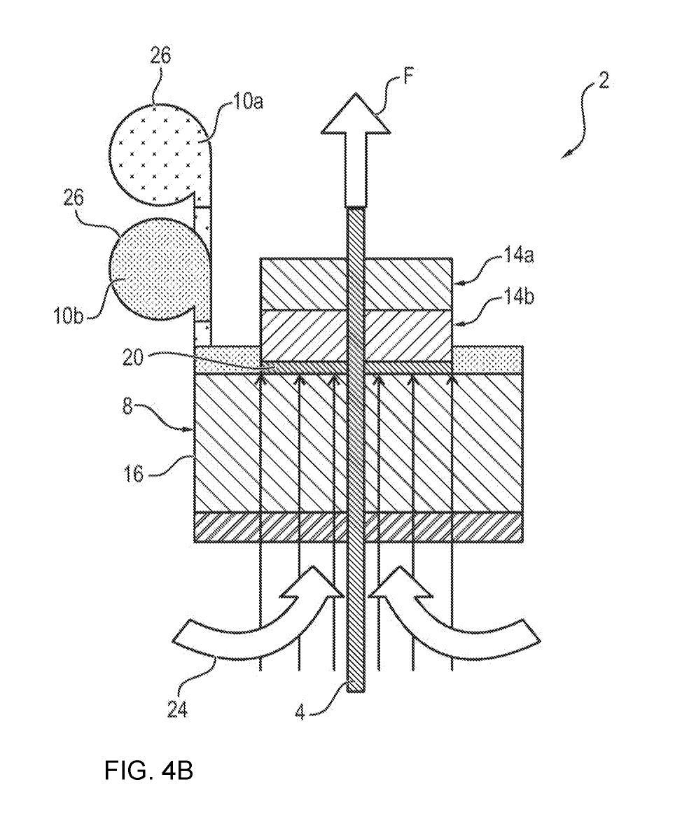

In order for the jacket 14 to be configured, dissimilar zones 16, 18, 20, are configured in the bath 8, specifically a dead zone 16 or non-curable zone, a normal zone 18 or curable zone in which the curable material 10 is curable by exposure, and a build-up zone 20 which is disposed in the border region between the dead zone 16 and the normal zone 18 and in which the curable material 10 for the purpose of curing is exposed in a locationally selective manner. Despite exposure, curing does not take place in the dead zone 16 since an inhibitor 24, presently oxygen, which prevents curing is streamed into the bath 8 by way of a semi-permeable wall 22. An inhibitor gradient is configured herein in the conveying direction F, such that the concentration of the inhibitor 24, proceeding from the wall 22, decreases and curing is possible as from a specific distance. This defines the build-up zone 20. The normal zone 18 and the dead zone 16 herein are not necessarily sharply delineated from one another, but rather are defined by the non-homogenous distribution and concentration of the inhibitor 24 in the bath 8. The build-up zone 20 in this instance is significantly defined by a specific concentration of the inhibitor 24, and by the exposure by the exposure source 12. The exposure in FIG. 1 is likewise performed in the conveying direction F. The material 10 is fed to the bath 8 from containers 26. Two dissimilar materials can also be fed from the containers 26 illustrated, and be mixed with one another, for example, or be sourced for a layered construction from dissimilar materials, as this is described in the context of FIGS. 4A, 4B.

The product in strand form 4 is conveyed longitudinally in the conveying direction F through the bath 8. The exposure and, on account thereof, the build-up of the jacket 14 within the build-up zone 20 is performed simultaneously. As a starting point for growing the jacket 14, a holding element 28 which initially serves for mechanically stabilizing the jacket 14 and later in the context of a post-treatment is removed by dissolving is attached here at a fixed longitudinal position of the product in strand form 4. It can be clearly seen in FIG. 1 that the jacket 14 is made as a complex three-dimensional structure. The structuring of the jacket 14 herein is significantly determined by the exposure, more specifically by an exposure pattern which is generated by the exposure source 12. This exposure pattern is temporally and/or spatially varied, on account of which, in combination with the conveying in the conveying direction F, an almost arbitrary structure is configured as the sheathing on the product in strand form 4.

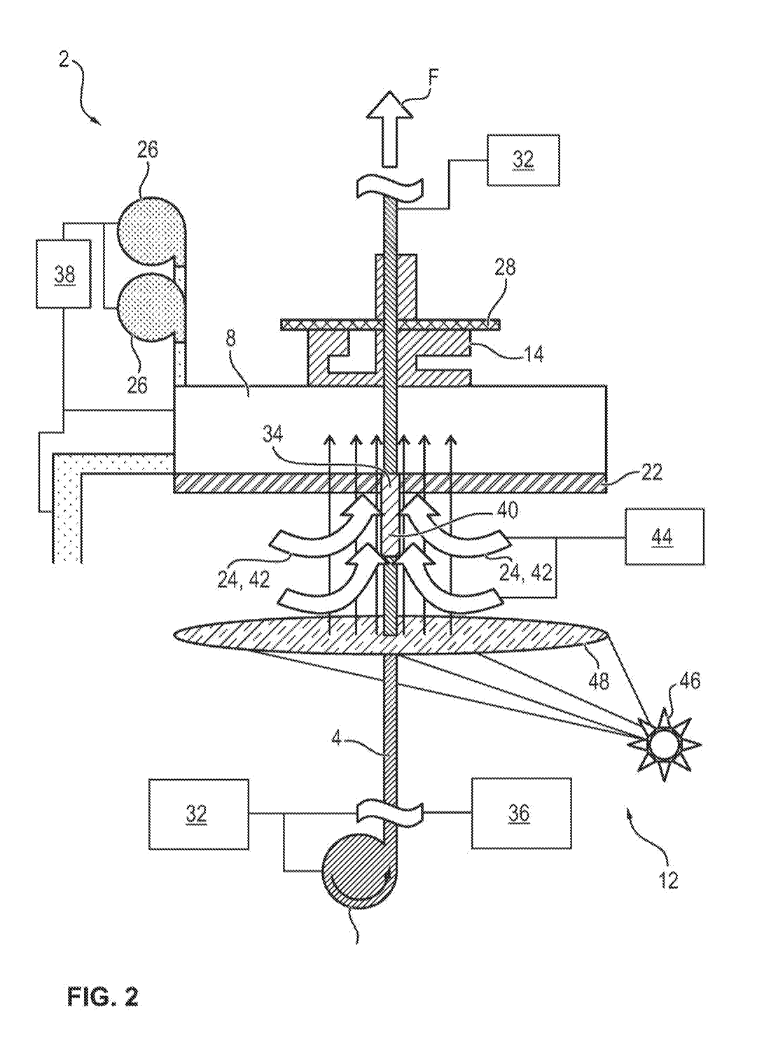

FIG. 2 shows a variant of the apparatus 2, which here has a support system 30 by which the product in strand form 4 is initially unwound and fed to the bath 8, and subsequently, after sheathing, is fed to a post-treatment, for example for cleaning, making up, or similar. The support system 30 herein has a control unit 32 for controlling the conveying speed of the product in strand form 4 through the bath 8. The control unit 32 in FIG. 2 serves in particular also for aligning the product in strand form 4 in relation to an opening 34 by way of which the product in strand form 4 is guided into the bath 8 by a distance measuring system 36. Furthermore, dissimilar materials 10 can be fed to the apparatus 2 and also be retrieved from the latter again by a material feed control 38.

The apparatus 2 in FIG. 2 moreover has a guide element 40 by which the product in strand form 4 is guided into the bath 8 through the wall 22, wherein the guide element 40 at the same time prevents the liquid, curable material 10 leaking through the opening 24. The guide element 40 in FIG. 2 is configured as a guide sleeve and sits tightly in the opening 24, and proceeding from the bottom of the bath 8, that is to say from the internal side of the wall 22, extends outward. The product in strand form 4, when exiting the guide sleeve, accordingly initially enters the dead zone 16, passes through the latter, and finally reaches the build-up zone 20.

In order for any leakage of the material 10 past the product in strand form 4 and through the guide element 40 to be prevented, a backpressure is configured in the guide element 40 in that a support medium 42 which retains the material 10 is streamed thereinto in the conveying direction F. The inhibitor 24 is used as a support medium 42 in FIG. 2. The backpressure is set by way of a gas pressure regulator 44.

FIG. 2 moreover shows an alternative to the direct illumination of FIG. 1, specifically an exposure source 12 which is a lamp 46 in combination with a mask or imaging optics 48.

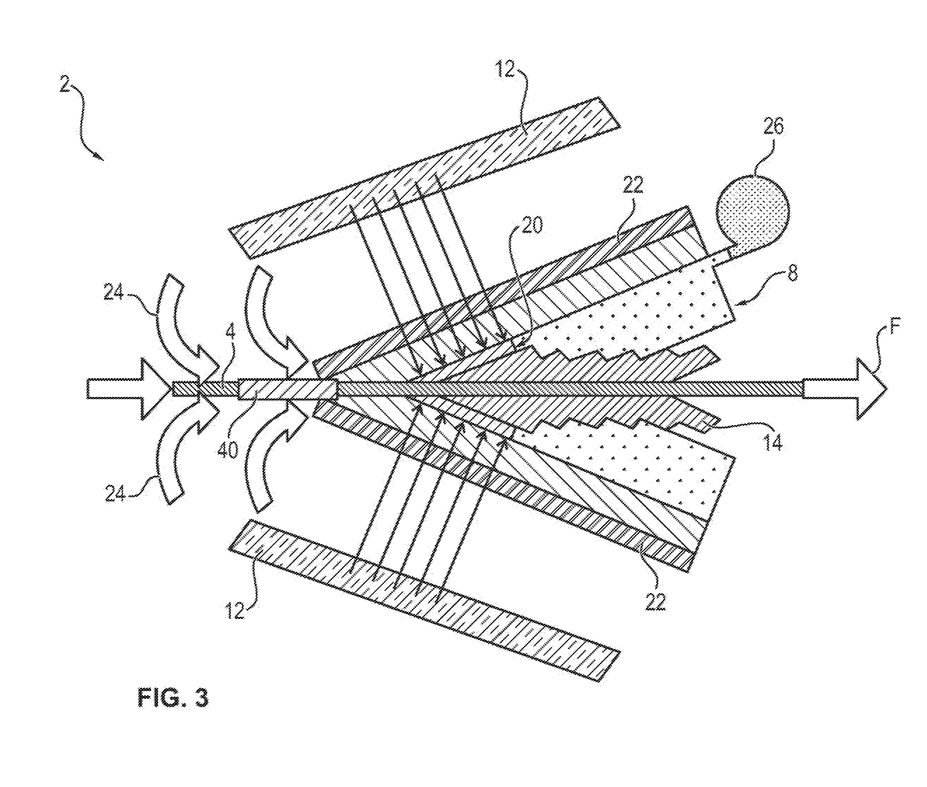

FIG. 3 shows a further variant of the apparatus 2 in which the wall 22 runs obliquely in relation to the conveying direction F and to the longitudinal axis of the product in strand form 4. The wall 22 herein is disposed so as to be rotationally symmetrical in relation to the conveying direction F and forms a conical shell surface within which the bath 8 is disposed. Moreover, an exposure emanating from a plurality of directions and in each case perpendicularly to the wall 22, that is to say here likewise obliquely to the conveying direction F, is performed in this design embodiment. The inhibitor 24 is also streamed in by way of the conical shell-surface-shaped wall 22, such that overall the dead zone 16 and the build-up zone 20 are in each case also configured so as to be conical shell-surface-shaped. On account thereof, the problem of potential shading of the exposure source 12 by the product in strand form 4 and/or the guide element 40 is circumvented.

FIGS. 4A and 4B show in each case a method step in the configuration of a jacket 14 having dissimilar jacket portions 14a, 14b from dissimilar materials 10a, 10b. The two materials 10a, 10b are present in layers and conjointly form the bath 8. The build-up zone 20 is then displaced to one of the two layers by controlling the inflow of the inhibitor 24. Therefore, in FIG. 4A a first jacket portion 14a is initially made from the first material 10a, the dead zone 16 is subsequently enlarged, that is to say an enlarged dead zone 16 is configured, and on account thereof the build-up zone 20 is displaced from the second material 10b to the layer. Finally, a second jacket portion 14b is configured from the second material 10b.

1. A method for producing a cable, which comprises the steps of:
applying a jacket to a product in strand form, by the further following steps of:
feeding the product in strand form to an apparatus which has a bath of a curable material, a build-up zone being configured within the bath and the curable material of the build-up zone is cured at least partially by at least one exposure source; and
conveying the product in strand form in a conveying direction through the bath such that cured material is disposed on the product in strand form and, functioning as the jacket on the product in strand form, is conveyed conjointly with the product in strand form out of the bath.

2. The method according to claim 1, which further comprises mounting the bath in a vessel which has an opening through which the product in strand form is fed to the bath.

3. The method according to claim 2, which further comprises conveying the product in strand form in the conveying direction through the opening and through the build-up zone.

4. The method according to claim 3, which further comprises disposing a guide element in the opening and via the guide element the product in strand form is conveyed into the bath and by which the vessel in a region of the opening is sealed.

5. The method according to claim 4, wherein the guide element has at least one of a diaphragm, a guide sleeve, a valve or a flap.

6. The method according to claim 4, which further comprises configuring an intermediate space in which a backpressure for retaining the curable material is built up by a support medium between the product in strand form and the guide element.

7. The method according to claim 6, which further comprises streaming a gaseous or liquid support medium in the conveying direction into the intermediate space.

8. The method according to claim 1, which further comprises providing the vessel with a semi-permeable wall, and the build-up zone is configured in that an inhibitor is introduced through the semi-permeable wall into the bath.

9. The method according to claim 8, wherein the semi-permeable wall runs obliquely to the conveying direction.

10. The method according to claim 8, wherein the semi-permeable wall runs perpendicularly to the conveying direction, and in that the exposure source is disposed so as to be eccentric or oblique in relation to the product in strand form.

11. The method according to claim 8, wherein the semi-permeable wall runs in a rotationally symmetrical manner in relation to the conveying direction, and forms a tip through which the product in strand form is conveyed into the bath.

12. The method according to claim 8, which further comprises curing the curable material by means of the exposure source and is exposed through the semi-permeable wall and obliquely to the conveying direction.

13. The method according to claim 1, which further comprises exposing the curable material to a plurality of exposure sources emanating from different directions.

14. The method according to claim 1, wherein the product in strand form has a circumferential contour which is not circular, wherein an exposure pattern which is adapted to the circumferential contour is generated by means of the exposure source and/or of a slide-in mask.

15. The method according to claim 14, wherein the circumferential contour varies along the product in strand form, and the exposure pattern is adapted to a variable circumferential contour while the product in strand form is conveyed through the bath.

16. The method according to claim 14, which further comprises adapting the exposure pattern to the circumferential contour in that the exposure source is rotated relative to the product in strand form and about the conveying direction.

17. The method according to claim 1, wherein the jacket is configured as a jacket that is variable in the conveying direction in that the curable material is exposed by way of a temporally variable exposure pattern.

18. The method according to claim 1, wherein the jacket is configured as a jacket that is variable in the conveying direction in that dissimilarly curable materials are used.

19. The method according to claim 1, which further comprises treating the product in strand form in a pre-treatment before the product in strand form is conveyed into the bath.

20. The method according to claim 19, which further comprises cleaning the product in strand form in the pre-treatment.

21. The method according to claim 19, which further comprises which further comprises heating the product in strand form in the pre-treatment.

22. The method according to claim 1, which further comprises guiding the product in strand form in a pre-treatment through a pre-treatment medium or a pre-treatment bath.

23. The method according to claim 22, which further comprises applying a slide, a release, or an oil coating to the product in strand form by means of the pre-treatment medium or of the pre-treatment bath.

24. The method according to claim 1, which further comprises exposing and curing the curable material in portions to dissimilar degrees in the conveying direction and/or in a radial direction, and on account thereof a plurality of jacket portions having dissimilar properties are configured.

25. The method according to claim 1, wherein the product in strand form, having the jacket, after the bath is fed to a post-treatment which varies in portions, so as to configure a plurality of jacket portions having dissimilar properties.

26. The method according to claim 1, which further comprises composing the bath with a plurality of curable materials which are disposed so as to be layered in the conveying direction, and in that the jacket is configured in portions from dissimilar curable materials in that the build-up zone is configured in a temporally sequential manner from the dissimilar curable materials.

27. The method according to claim 1, wherein prior to an application of the jacket, attaching a holding element at a predefined longitudinal position of the product in strand form.

28. The method according to claim 1, which further comprises configuring the jacket as a structured and/or smooth sheathing.

29. A cable, comprising:
a product in strand form; and
a complexly-shaped jacket surrounding said product in strand form, said jacket made from an at least partially cured material and is applied to said product in strand form.

30. The cable according to claim 29, wherein said product in strand form is an electrical or optical transmission conductor being a bunched conductor.

31. An apparatus, comprising:
a vessel in which a bath of a curable material is disposed;
a feed having an opening formed therein for feeding a product in strand form into the bath; and
at least one exposure source for curing the curable material.

32. A control method, which comprises the steps of:
providing an apparatus having a vessel in which a bath of a curable material is disposed, a feed having an opening formed therein for feeding a product in strand form into the bath, and at least one exposure source for curing the curable material; and
actuating the exposure source in order for a jacket to be configured so as to have a plurality of dissimilar jacket portions, and for a temporally variable exposure pattern for exposing the curable material to be generated.

33. A non-transitory computer readable medium carrying computer executable instructions when installed on a computer automatically executing a control method for actuating an exposure source in order for a jacket to be configured so as to have a plurality of dissimilar jacket portions, and for a temporally variable exposure pattern for exposing a curable material to be generated in an apparatus having a vessel in which a bath of the curable material is disposed, the vessel further having a feed having an opening formed therein for feeding a product in strand form into the bath, and the least one exposure source for curing the curable material.
